(19) United States
(12) Patent Application Publication
(10) Pub. No.: US 2010/0321369 A1
(43) Pub. Date: Dec. 23, 2010

(54) BACKLIGHT DEVICE AND DISPLAY EQUIPPED WITH THE DEVICE

(75) Inventor: Shiyoshi Cho, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/918,064

(22) PCT Filed: Feb. 12, 2009
(86) PCT No.: PCT/JP2009/052306

§ 371 Date: Aug. 18, 2010

(30) Foreign Application Priority Data
Feb. 20, 2008 (JP) 2008-039130

(51) Int. Cl. G06F 3/038; H05B 41/36

(52) U.S. Cl. 345/211; 315/246; 315/276

(57) ABSTRACT

The present invention provides a backlight device that can ensure the margin for design of the placement of a circuit board by simplifying the configuration of a lighting circuit of a lamp and reducing the size of the circuit board on which circuit components are mounted, and a display device using the backlight device. The backlight device includes a lamp (20) and a lighting circuit (21) that generates a lighting drive voltage to light and drive the lamp (20). The lighting circuit (21) includes the following: a direct-current power supply circuit (33) that generates a direct-current voltage from an input voltage; an inverter drive circuit (43) that converts the direct-current voltage output from the direct-current power supply circuit (33) into a high frequency voltage; and a booster portion (T2) that boosts the high frequency voltage output from the inverter drive circuit (43) to a lighting drive voltage of the lamp (20). The direct-current power supply circuit (33) and the inverter drive circuit (43) are disposed on different circuit boards.

### TECHNICAL FIELD

The present invention relates to a backlight device that provides a lighting drive voltage of a lamp by an inverter circuit, and a display device using the backlight device.

### BACKGROUND ART

In recent years, a liquid crystal display device characterized by low power consumption, small thickness, lightweight, etc. has been widely used as a display device for televisions. A liquid crystal panel, i.e., a display element used in a display portion of the liquid crystal display device is a so-called non-emission type display element that does not emit light itself. Therefore, a light source called a backlight device is provided generally on the back of the liquid crystal panel, and the degree of transmission of light emitted from the backlight device is controlled by a liquid crystal layer, so that images are displayed.

The backlight device of the liquid crystal display device is required to illuminate the entire surface of the image display region of the liquid crystal panel with illumination light having uniform brightness and color. In the backlight device, two methods, i.e., a direct method and an edge light method are known to provide illumination light having uniform brightness and color over the entire surface of the image display region of the liquid crystal panel.

The direct type backlight device is a surface-emitting light source in which many light sources are arranged in a plane on the back of the liquid crystal panel, and light emitted from the individual light sources passes through a diffusing plate or a lens sheet, thereby making the brightness of the light uniform. On the other hand, the edge light type (also referred to as sidelight type) backlight device is a surface-emitting light source in which light from a light source enters the side of a light guide plate having a shape that corresponds to the image display region of the liquid crystal panel, and then the light propagates while being reflected repeatedly in the light guide plate and finally exits toward the liquid crystal panel.

In the liquid crystal display device including a liquid crystal panel of 20 inches or more used for a television set, the direct type backlight device is used in general, since it is easier to achieve high brightness and large size than the edge light type backlight device. Moreover, the direct type backlight device has a hollow structure inside, and therefore is lightweight even if the size is increased. In this regard, the direct type backlight device is suitable for high brightness and large size.

Fluorescent lamps are used as light sources of the direct type backlight device. In many cases, cold-cathode fluorescent tubes (CCFTs) have been used conventionally as the fluorescent lamps. Moreover, an inverter circuit that provides a lighting drive voltage by boosting a commercial alternating-current voltage (input voltage) with an inverter transformer is used as a circuit to light and drive the cold-cathode fluorescent tubes.

FIG. 4 is a block diagram showing a lighting circuit for cold-cathode fluorescent tubes (lamps) used in a conventional backlight device. As shown in FIG. 4, the conventional lighting circuit includes a power supply circuit board 50 and an inverter circuit board 60.

The power supply circuit board 50 includes a rectifier 52, a direct-current power supply circuit 53, and a PFC (power factor controller) control circuit 54. The rectifier 52 is connected to a commercial power supply 51 (e.g., 100 V in Japan). The direct-current power supply circuit 53 converts the voltage that is rectified by the rectifier 52 into, e.g., a direct-current voltage of 370 V. The PFC control circuit 54 improves the power factor of the direct-current power supply circuit 53 by suppressing harmonics. The power supply circuit board 50 also includes an isolated DC/DC converter 55 and a signal isolated converter 56. The isolated DC/DC converter 55 converts the direct-current voltage output from the direct-current power supply circuit 53 into, e.g., a voltage of 60V and isolates the direct-current power supply circuit 53 on the primary side from the inverter circuit board 60 on the secondary side. The signal isolated converter 56 converts the direct-current voltage output from the direct-current power supply circuit 53 into a voltage required for a liquid crystal panel drive circuit and a signal processing circuit (both are not shown) other than the backlight light source and isolates the output from the input.

The inverter circuit board 60 includes an inverter drive circuit 61 and a booster circuit 63. The inverter drive circuit 61 generates a high frequency voltage from the direct-current voltage (e.g., 60 V) that is received from the power supply circuit board 50. The booster circuit 63 boosts the high frequency voltage to a lighting drive voltage (e.g., about 2 kV) for cold-cathode fluorescent tubes 20a to 20c. Detectors 64a to 64c are connected to the secondary side of inverter transformers T11a to T11c of the booster circuit 63 and monitor the lamp current values of the cold-cathode fluorescent tubes 20a to 20c, respectively. The outputs of the detectors 64a to 64c are input to an inverter control portion 62 that adjusts the timing of inverter control. Specifically, the inverter control portion 62 adjusts the timing of on/off of switching elements Q2, Q3 of the inverter drive circuit 61 and then performs feedback control of the lighting drive voltage for the cold-cathode fluorescent tubes 20a to 20c.

When the lighting circuit for the cold-cathode fluorescent tubes shown in FIG. 4 is mounted in a liquid crystal display device, the circuit boards are placed on the back of the backlight device. In such a case, the inverter circuit board 60 is located near the periphery of the liquid crystal display device so as to be closer to the electrodes at the ends of the fluorescent tubes arranged in the backlight device. However, as shown in FIG. 4, when the inverter drive circuit 61 and the booster circuit 63 are formed on the inverter circuit board 60, the inverter circuit board 60 is large in size, and the circuit components with a relatively large height are increased. Consequently, a relatively large space that accommodates the circuit boards is required on the back of the backlight device of the liquid crystal display device. This leads to the constraint that other components cannot be located near the periphery of the liquid crystal display device.

To avoid such a constraint, the combination of the functions of a direct-current power supply circuit and an inverter circuit in a lighting circuit of a lamp, namely LIPS (LCD integrated power supply) has been proposed.

FIG. 5 is a block diagram showing another example of the lighting circuit that combines the functions of the direct-current power supply circuit and the inverter circuit.

As shown in FIG. 5, in the lighting circuit that combines the functions of the direct-current power supply circuit and the inverter circuit, the inverter drive circuit 61 is provided on the power supply circuit board 50. Therefore, the output of the direct-current power supply circuit 53 is input directly to the inverter drive circuit 61, where a high frequency voltage is generated from, e.g., a direct-current voltage of 370 V. The output of the inverter drive circuit 61 is transmitted to the inverter circuit board 60 via an isolation transformer T12.

The inverter circuit board 60 includes the booster circuit 63 that boosts the high frequency direct-current voltage (e.g., 60 V) received from the power supply circuit board 50 to a lighting drive voltage (about 2 kV) for the cold-cathode fluorescent tubes 20a to 20c. The detectors 64a to 64c are connected to the secondary side of the inverter transformers T11a to T11c of the booster circuit 63 and provide the information about the lamp current values of the cold-cathode fluorescent tubes 20a to 20c, respectively. The information is input to the inverter control portion 62 of the power supply circuit board 50. The inverter control portion 62 adjusts the timing of on/off of the switching elements Q2, Q3 of the inverter drive circuit 61 and then performs feedback control of the lighting drive voltage for the cold-cathode fluorescent tubes 20a to 20c.

In the lighting circuit that combines the functions of the direct-current power supply circuit and the inverter circuit shown in FIG. 5, the inverter circuit provided on the inverter circuit board 60 of the conventional lighting circuit shown in FIG. 4 is divided, and the inverter drive circuit 61 other than the booster circuit 63 is transferred to the power supply circuit board 50. Thus, an inverter circuit unit 70 is formed across the two circuit boards.

Patent Document 1 discloses an example of a lighting circuit of a fluorescent tube that includes a direct-current power supply circuit and an inverter circuit.

Patent Document 1: JP 2003-203795 A

### DISCLOSURE OF INVENTION

### Problem to be Solved by the Invention

In the lighting circuit that combines the functions of the direct-current power supply circuit and the inverter circuit shown in FIG. 5, since the number of the components of the inverter circuit board 60 is reduced, the constraint on the placement of the circuit boards in a television set can be reduced significantly.

However, in the lighting circuit that combines the functions of the direct-current power supply circuit and the inverter circuit, the direct-current power supply circuit 53 and the inverter drive circuit 61 are disposed on the same power supply circuit board 50. Therefore, the size of the power supply circuit board 50 is increased, which may impose a considerable constraint on the placement of the circuit boards on the back of the liquid crystal display device. For example, in the case of the liquid crystal display device as a television set, there may be a wide variation in the power supply circuit board 50 according to the voltage value and frequency of a commercial power supply in each country, depending on the destinations of the television sets. Thus, even if the specification of the inverter drive circuit 61 is the same, the power supply circuit board 50 should have variations based on the specification of the direct-current power supply circuit 53. This makes the management of the circuit boards complicated and also increases the cost. Moreover, the operation check or test of the inverter circuit alone cannot be performed.

With the foregoing in mind, it is an object of the present invention to provide a backlight device that can ensure the margin for design of the placement of a circuit board particularly by simplifying the configuration of a lighting circuit of a lamp serving as a light source and reducing the size of the circuit board on which circuit components are mounted, and a display device using the backlight device.

### Means for Solving Problem

To achieve the above object, a backlight device of the present invention includes a lamp and a lighting circuit that generates a lighting drive voltage to light and drive the lamp. The lighting circuit includes the following: a direct-current power supply circuit that generates a direct-current voltage from an input voltage; an inverter drive circuit that converts the direct-current voltage output from the direct-current power supply circuit into a high frequency voltage; and a booster portion that boosts the high frequency voltage output from the inverter drive circuit to a lighting drive voltage of the lamp. The direct-current power supply circuit and the inverter drive circuit are disposed on different circuit boards.

A display device of the present invention includes a display portion and the backlight device of the present invention. The display portion is irradiated with light from the backlight device.

### EFFECTS OF THE INVENTION

The present invention can provide a backlight device that reduces the constraint on the placement of a circuit board in a lighting circuit of a lamp. The present invention also can achieve a small thin display device by using the backlight device.

### BRIEF DESCRIPTION OF DRAWINGS

FIG. 1 is an exploded perspective view showing a schematic configuration of a liquid crystal display device according to an embodiment of the present invention.

FIG. 2 is a block diagram showing a configuration of a lighting circuit of a backlight device according to Embodiment 1 of the present invention.

FIG. 3 is a block diagram showing a configuration of a lighting circuit of a backlight device according to Embodiment 2 of the present invention.

FIG. 4 is a block diagram showing a configuration of a lighting circuit of a conventional backlight device.

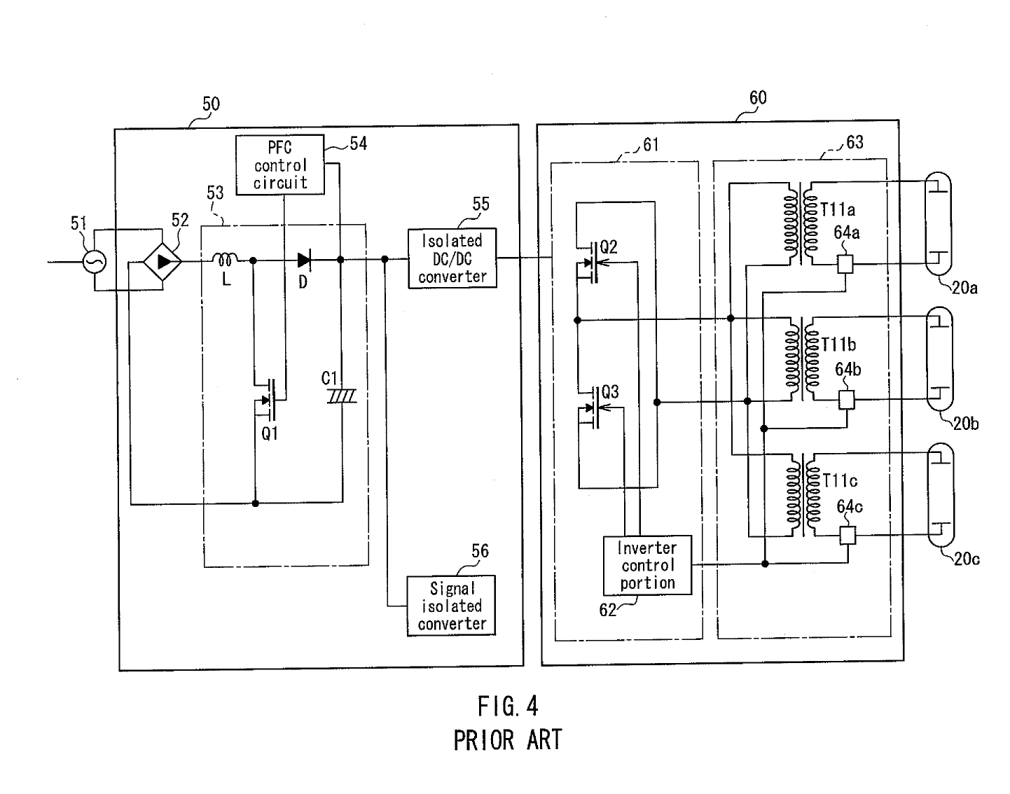

FIG. 5 is a block diagram showing a configuration of another lighting circuit of a conventional backlight device.

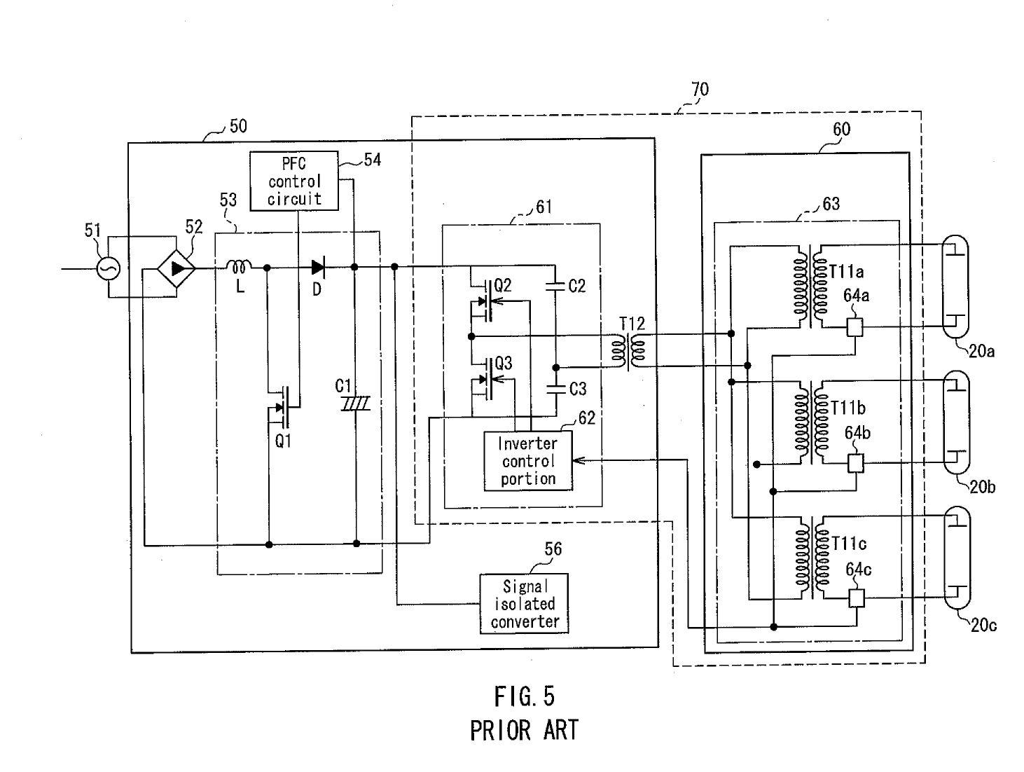

### DESCRIPTION OF THE INVENTION

The backlight device of the present invention includes a lamp and a lighting circuit that generates a lighting drive voltage to light and drive the lamp. The lighting circuit includes the following: a direct-current power supply circuit that generates a direct-current voltage from an input voltage; an inverter drive circuit that converts the direct-current voltage output from the direct-current power supply circuit into a high frequency voltage; and a booster portion that boosts the high frequency voltage output from the inverter drive circuit to a lighting drive voltage of the lamp. The direct-current power supply circuit and the inverter drive circuit are disposed on different circuit boards.

With this configuration, it is possible to simplify the whole circuit configuration of the lighting circuit that generates a high frequency voltage from the direct-current voltage output from the direct-current power supply circuit. Moreover, the inverter drive circuit is disposed on a different circuit board from the direct-current power supply circuit. This increases the margin for design of the placement of the circuit boards of the lighting circuit in the backlight device. Further, even if the direct-current power supply circuits with different specifications are used, the specifications of the direct-current power supply circuits can be changed.

In the above configuration, the booster portion may be an inverter transformer in a booster circuit that is disposed on a different circuit board from the inverter drive circuit.

With this configuration, the circuit board on which the inverter drive circuit is disposed and the circuit board on which the booster circuit is disposed can be connected at a low voltage. Therefore, the safety in the connection can be improved.

In the above configuration, the booster portion may be an isolation booster transformer that is disposed on the same circuit board as the inverter drive circuit.

With this configuration, the transformer that provides isolation between the portion for lighting and driving the lamp (light source) and the portion for generating a direct-current voltage also can be used as a transformer (booster portion) that boosts the high frequency voltage. Therefore, there is no need to provide a boosting transformer for each lamp. Accordingly, the configuration of the lighting circuit can be simplified further.

It is preferable that the lamp is a cold-cathode fluorescent tube. Thus, the backlight device of the display device can be achieved using the cold-cathode fluorescent tube that is the most common lamp.

The display device of the present invention includes a display portion and the backlight device of the present invention. The display portion is irradiated with light from the backlight device.

With this configuration, the display device of the present invention makes good use of the properties of the backlight device of the present invention that can simplify the lighting circuit and increase the margin for design of the placement of the circuit boards constituting the lighting circuit. Thus, the display device of the present invention can be made smaller and thinner.

Hereinafter, preferred embodiments of the backlight device and the display device of the present invention will be described with reference to the drawings. In the following, a liquid crystal display device for a television receiver that includes a transparent liquid crystal panel (display potion) is described as an example of the display device of the present invention. However, the applicability of the present invention is not limited to the following description. For example, the display portion of the present invention can be a semi-transparent liquid crystal panel. Moreover, the display portion is not limited to a liquid crystal panel, and can be another display element that displays an image using illumination light from the backlight device as a light source. The application of the display device of the present invention is not limited to the television receiver.

### Embodiment 1

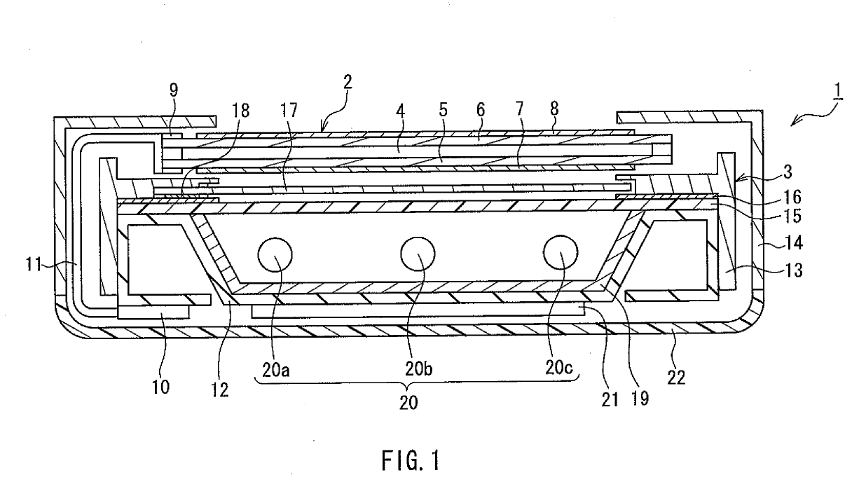

FIG. 1 is a schematic cross-sectional view showing a backlight device and a liquid crystal display device including the backlight device according to an embodiment of the present invention. As shown in FIG. 1, a liquid crystal display device 1 of this embodiment includes a liquid crystal panel 2 (display portion) and a backlight device 3. The liquid crystal panel 2 is placed with the upper side of FIG. 1 being identified as a viewer side (display surface side). The backlight device 3 is placed on the non-display surface side of the liquid crystal panel 2 (i.e., the lower side of FIG. 1) and irradiates the liquid crystal panel 2 with planar light.

The liquid crystal panel 2 includes a liquid crystal layer 4, a pair of transparent substrates 5, 6 that sandwich the liquid crystal layer 4, and polarizing plates 7, 8 that are provided on the outer surfaces of the transparent substrates 5, 6, respectively. The liquid crystal panel 2 also includes a driver 9 for driving the liquid crystal panel 2 and a drive circuit 10 connected to the driver 9 via a flexible printed board 11.

The liquid crystal panel 2 is an active matrix liquid crystal panel and is configured so that scanning lines and data lines are arranged in a matrix, a scanning signal and a data signal are supplied to the scanning lines and the data lines, and thus the liquid crystal layer 4 can be driven pixel by pixel. In the individual pixels, a TFT (switching element) is provided in the vicinity of each of the intersections of the scanning lines and the data lines. When the TFTs are turned on by the signal of the scanning line, the alignment of the liquid crystal molecules is changed with the potential level of the data signal that is written into the pixel electrode from the data line. Consequently, the gradation display is performed in accordance with the data signal. In the liquid crystal panel 2, the polarization state of the light that has entered from the backlight device 3 through the polarizing plate 7 is modulated by the liquid crystal layer 4, and the amount of light passing through the polarizing plate 8 is controlled, thereby displaying a desired image.

The backlight device 3 includes a case 12 that has a bottom and is open to the liquid crystal panel 2 side (i.e., the upper side of FIG. 1), and a frame 13 that is provided on the case 12 near the liquid crystal panel 2. The case 12 and the frame 13 are made of a metal or a synthetic resin and sandwiched between bezels 14, each of which has an L-shaped cross section, while the liquid crystal panel 2 is located above the frame 13. With this configuration, the backlight device 3 is joined to the liquid crystal panel 2, so that they are integrated into the transmission-type liquid crystal display device 1 in which illumination light from the backlight device 3 enters the liquid crystal panel 2.

The backlight device 3 includes a diffusing plate 15 that covers the opening of the case 12, an optical sheet 17 that is located above the diffusing plate 15 to face the liquid crystal panel 2, and a reflecting sheet 19 that is provided on the inner surface of the case 12. The backlight device 3 also includes cold-cathode fluorescent tubes (CCFL) 20 that are lamps serving as light sources. The cold-cathode fluorescent tubes 20 are provided above the reflecting sheet 19 and arranged at a predetermined pitch so that their longitudinal directions are substantially in the same direction. Light emitted from the cold-cathode fluorescent tubes 20 is directed to the liquid crystal panel 2 as planar light. For the sake of simplification, FIG. 1 and the other drawings of this embodiment show three cold-cathode fluorescent tubes 20a, 20b, and 20c. However, the number of the cold-cathode fluorescent tubes is not limited thereto. For example, in the case of a liquid crystal display device for a 32-inch screen TV, fourteen cold-cathode fluorescent tubes are arranged in parallel.

The diffusing plate 15 is made of, e.g., a synthetic resin or a glass material with a thickness of about 2 mm. The diffusing plate 15 diffuses light from the cold-cathode fluorescent tubes 20 (including the light reflected from the reflecting sheet 19) and emits the diffused light toward the optical sheet 17. The four sides of the diffusing plate 15 are placed on the surface of the outer frame of the case 12, and sandwiched between this surface of the case 12 and the inner surface of the flame 13 via an elastically deformable pressing member 16. Thus, the diffusing plate 15 is incorporated into the backlight device 3. Moreover, the central portion of the diffusing plate 15 is supported by a transparent supporting member (not shown) located on the reflecting sheet 19. This can prevent the diffusing plate 15 from being bent inward. The diffusing plate 15 including the glass material, which has higher heat resistance than the synthetic resin, is preferred because it is not likely to cause warpage, yellowing, deformation, etc. under the influence of heat.

The optical sheet 17 includes a condenser sheet made of, e.g., a synthetic resin film with a thickness of about 0.5 mm to improve the brightness of the illumination light from the backlight device 3 to the liquid crystal panel 2. Moreover, an optical sheet material such as a prism sheet, a diffusing sheet, or a polarizing sheet may be formed on the optical sheet 17 as needed to improve the display quality on the display surface of the liquid crystal panel 2. The optical sheet 17 has a protrusion that protrudes to the left of FIG. 1, and this protrusion is sandwiched between the inner surface of the frame 13 and the pressing member 16 via an elastic material 18.

The optical sheet 17 converts the light emitted from the diffusing plate 15 into planar light having a uniform brightness not less than a predetermined value (e.g., 10000 cd/m²) and allows the planar light to enter the liquid crystal panel 2 as illumination light. In addition to the above configuration, e.g., an optical member such as a diffusing sheet for controlling the viewing angle of the liquid crystal panel 2 may be formed on the liquid crystal panel 2 (i.e., the display surface side) as needed.

The reflecting sheet 19 is made of, e.g., a metal thin film that has a high optical reflectance such as aluminum or silver and a thickness of about 0.2 to 0.5 mm. The reflecting sheet 19 functions as a reflector that reflects light from the cold-cathode fluorescent tubes 20a to 20c toward the diffusing plate 15. Thus, in the backlight device 3, both the utilization efficiency of light from the cold-cathode fluorescent tubes 20 and the brightness of light from the diffusing plate 15 can be improved. The inner surface of the case 12 may be provided as a reflector, e.g., by using a reflecting sheet material of a synthetic resin instead of the metal thin film or applying a white coating with a high optical reflectance to the inner surface of the case 12.

The cold-cathode fluorescent tubes 20 are fluorescent-lamp-type thin straight tubes with excellent luminous efficacy, each of which has a diameter of about 3.0 to 4.0 mm. The cold-cathode fluorescent tubes 20a to 20c are held in the case 12 by a light source holder (not shown) while maintaining a predetermined distance between each of the diffusing plate 15, the fluorescent tube, and the reflecting sheet 19. Moreover, the cold-cathode fluorescent tubes 20a to 20c are arranged so that their longitudinal directions are parallel to the direction perpendicular to the direction of gravity. This configuration can prevent the mercury (vapor) filled in each of the cold-cathode fluorescent tubes 20 from concentrating at one end in the longitudinal direction by the action of gravity. Thus, the lamp life can be improved significantly.

A lighting circuit 21 for supplying a lighting drive voltage to light and drive the cold-cathode fluorescent tubes 20a to 20c is placed on the back of the case 12 of the backlight device 3. Connection terminals (not shown) are connected to electrode portions (not shown) of each of the cold-cathode fluorescent tubes 20a to 20c. The connection terminals are provided on both ends of the liquid crystal display device 1 in the lateral direction (i.e., the vertical direction of the sheet of FIG. 1) during operation and correspond to the positions of the ends of each of the cold-cathode fluorescent tubes 20a to 20c. In the lighting circuit 21, a booster circuit boosts a high frequency voltage to a lighting drive voltage to drive the cold-cathode fluorescent tubes 20, and is located near the connection terminals, i.e., in the vicinity of either the left or right end of the liquid crystal display device 1 during operation, since it is preferable to make the length of high-voltage wiring installed as short as possible.

The back of the liquid crystal display device 1 is covered with a back cover 22. The back cover 22 is made of a resin or a metal and serves not only to protect the drive circuit 10 of the liquid crystal panel 2 and the lighting circuit 21 of the cold-cathode fluorescent tubes 20, but also to improve the safety by preventing users from getting an electric shock. In view of the appearance of the liquid crystal display device 1, the peripheral portions of the back cover 22 are often curved as shown in FIG. 1 or tapered to impress the thinness of the liquid crystal display device 1 on users.

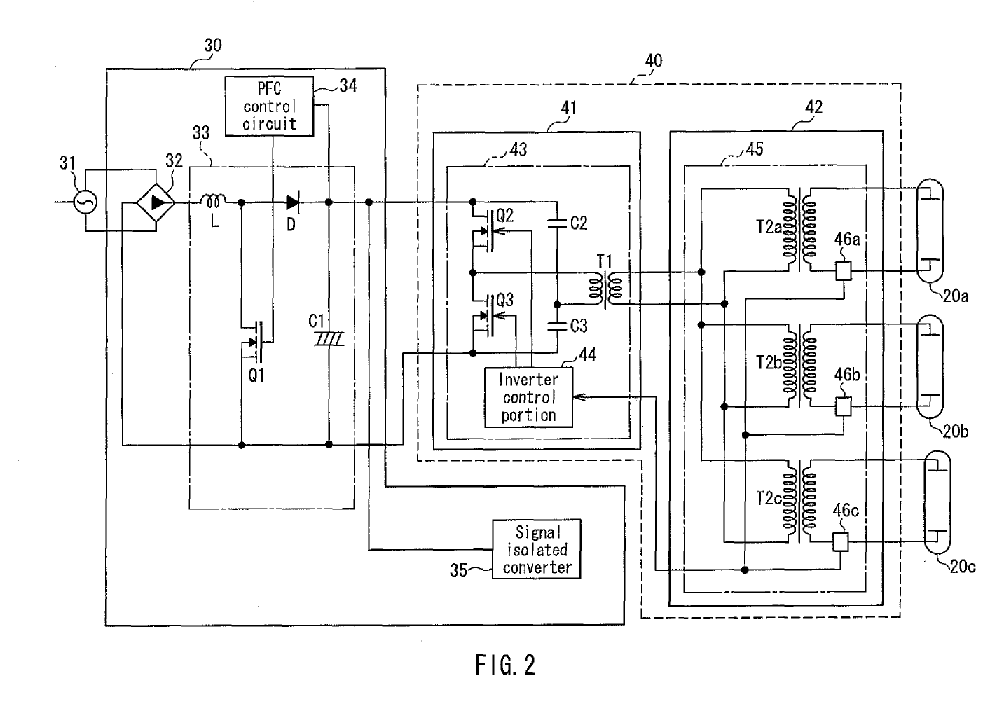

Next, the lighting circuit for lighting the cold-cathode fluorescent tubes (lamps) as light sources of the backlight device of this embodiment will be described with reference to FIG. 2.

FIG. 2 is a block diagram showing the circuit configuration of the lighting circuit that generates a lighting drive voltage for the cold-cathode fluorescent tubes 20a to 20c of the backlight device of this embodiment. As shown in FIG. 2, the lighting circuit of the backlight device of this embodiment includes a power supply unit and an inverter unit 40. The power supply unit is disposed on a power supply circuit board 30 that generates a predetermined direct-current voltage from a commercial power supply 31. The inverter unit 40 generates a lighting drive voltage required to light and drive the cold-cathode fluorescent tubes 20a to 20c from the direct-current voltage generated in the power supply unit.

The power supply unit formed on the power supply circuit board 30 includes a rectifier 32, a direct-current power supply circuit 33, a PFC (power factor controller) control circuit 34, and a signal isolated converter 35. The rectifier 32 is connected to the commercial alternating-current power supply 31 (e.g., 100 V in Japan) that is input externally via a power code of the liquid crystal display device 1. The direct-current power supply circuit 33 converts the output of the rectifier 32 into, e.g., a direct-current voltage of 370 V. The PFC control circuit 34 improves the power factor of the direct-current power supply circuit 33 by suppressing harmonics. The signal isolated converter 35 receives the direct-current voltage from the direct-current power supply circuit 33.

The direct-current power supply circuit 33 includes at least a series circuit of an inductor L and a diode D connected to the high-voltage output side of the rectifier 32, a switching element Q1 connected between the output terminals of the rectifier 32 via the inductor L, and a smoothing capacitor C1 connected in parallel to the switching element Q1 via the diode D. The direct-current power supply circuit 33 forms a boost chopper circuit that provides a desired direct-current voltage from the rectified voltage by turning the switching element Q1 on/off.

The PFC control circuit 34 monitors the output voltage on the high-voltage output side of the direct-current power supply circuit 33 and controls the switching element Q1. In this manner, the direct-current power supply circuit 33 can be a PFC-equipped power supply circuit, and the power factor can be improved by suppressing the harmonics contained in the alternating-current input voltage. Thus, the active power in the alternating-current power can be increased during the voltage conversion from the alternating current to the direct current, so that the voltage conversion efficiency can be improved.

The signal isolated converter 35 is a DC/DC converter that converts the direct-current voltage output from the direct-current power supply circuit 33 into a power supply voltage to drive various control circuits in the liquid crystal display device such as, although not shown in FIG. 2, a signal processing circuit for image and voice, a drive circuit of the liquid crystal panel, and an inverter control portion 44 that controls an inverter circuit of the lighting circuit of the cold-cathode fluorescent tubes, which will be described later. The various control circuits in the liquid crystal display device are formed mainly on the basis of a semiconductor device. Therefore, the output voltage of the signal isolated converter 35 is relatively low, e.g., 5V, 12V, or 24V. As described above, since the output voltage of the direct-current power supply circuit 33 is, e.g., 370 V, the signal isolated converter 35 uses a transformer to perform a voltage conversion from the input voltage on the primary side to the output voltage on the secondary side, and also ensures the isolation between the primary side and the secondary side.

The specific configuration of the direct-current power supply circuit is not limited to that described in this embodiment, and the PFC control circuit is not essential. There is no structural limitation as long as the direct-current power supply circuit can convert the commercial alternating-current voltage input through the power code of the liquid crystal display device into a desired direct-current voltage.

The inverter unit 40 includes an inverter circuit board 41 and a lighting voltage supply board 42.

The inverter circuit board 41 includes an inverter drive circuit 43. The inverter drive circuit 43 receives the direct-current voltage from the direct-current power supply circuit 33 of the power supply unit and generates a high frequency voltage by inverter control. Specifically, the inverter drive circuit 43 is a half-bridge inverter circuit in which a series circuit of switching elements Q2, Q3 formed of MOSFETs is connected between the high-voltage output side and the low-voltage output side of the direct-current power supply circuit 33.

A series circuit of direct-current cut capacitors C2, C3 is connected in parallel to the series circuit of the switching elements Q2, Q3. The direct-current voltage output from the direct-current power supply circuit 33 is converted into an alternating-current high frequency voltage by alternately turning the switching elements Q2, Q3 on/off based on a control signal from the inverter control portion 44.

A primary coil of an isolation transformer T1 is connected between the midpoint between the switching elements Q2, Q3 and the midpoint between the capacitors C2, C3. A secondary coil of the isolation transformer T1 is connected to a booster circuit 45 of the lighting voltage supply board 42, as will be described later. Cold-cathode fluorescent tubes 20a to 20c are connected to the booster circuit 45. There is a possibility that a person will touch the cold-cathode fluorescent tubes for maintenance etc. In view of the safety, therefore, the isolation transformer T1 prevents a direct connection between the power supply unit and the cold-cathode fluorescent tubes.

The booster circuit 45 formed on the lighting voltage supply board 42 boosts the high frequency voltage (e.g., 60 V) output from the inverter drive circuit 43 to a lighting drive voltage (e.g., 2 kV) that is to be applied to the electrodes of the cold-cathode fluorescent tubes 20a to 20c. Specifically, primary coils of inverter transformers (booster portions) T2a to T2c are connected in parallel to the secondary coil of the isolation transformer T1 of the inverter drive circuit 43. Both electrodes of each of the cold-cathode fluorescent tubes 20a to 20c are connected to both ends of the respective secondary coils of the inverter transformers T2a to T2c.

Detectors 46a to 46c for detecting lamp currents of the cold-cathode fluorescent tubes 20a to 20c are connected to one end of the secondary coils of the inverter transformers T2a to T2c to keep track of the lighting states of the cold-cathode fluorescent tubes 20a to 20c, respectively. The detection results of the detectors 46a to 46c are fed back to the inverter control portion 44 of the inverter drive circuit 43. Thus, the inverter circuit stabilizes the supply of the lighting drive voltage so that the brightness of the cold-cathode fluorescent tubes 20a to 20c can be maintained constant.

As described above, in the backlight device of the liquid crystal display device of this embodiment, the direct-current power supply circuit 33 and the inverter drive circuit 43, which is a part of the inverter unit 40, are disposed on different circuit boards. Moreover, in the inverter unit 40, the inverter drive circuit 43 is formed on the inverter circuit board 41, and the booster circuit 45 is formed on the lighting voltage supply board 42. That is, the circuit components constituting the inverter unit 40 are separated into two circuit boards. By dividing the circuit boards of the lighting circuit for the cold-cathode fluorescent tubes (lamps), it is possible to increase the margin for design of the placement of the circuit boards on the back of the backlight device. In particular, when the direct-current power supply circuit and the inverter control circuit are disposed on different circuit boards, the area of each of the circuit boards is reduced, thereby increasing the degree of freedom in the placement of the circuit boards. Moreover, although various specifications may be applied to the power supply circuit board depending on the destination and intended use of the liquid crystal display device, the power supply circuit board can be designed and employed independently of the inverter unit. Therefore, the power supply circuit and the inverter circuit can be managed separately, so that the manufacturing cost of the backlight device or the liquid crystal display device can be reduced.

### Embodiment 2

Next, a display device according to Embodiment 2 of the present invention will be described by way of example in which a lighting circuit for lighting lamps has a different circuit board configuration.

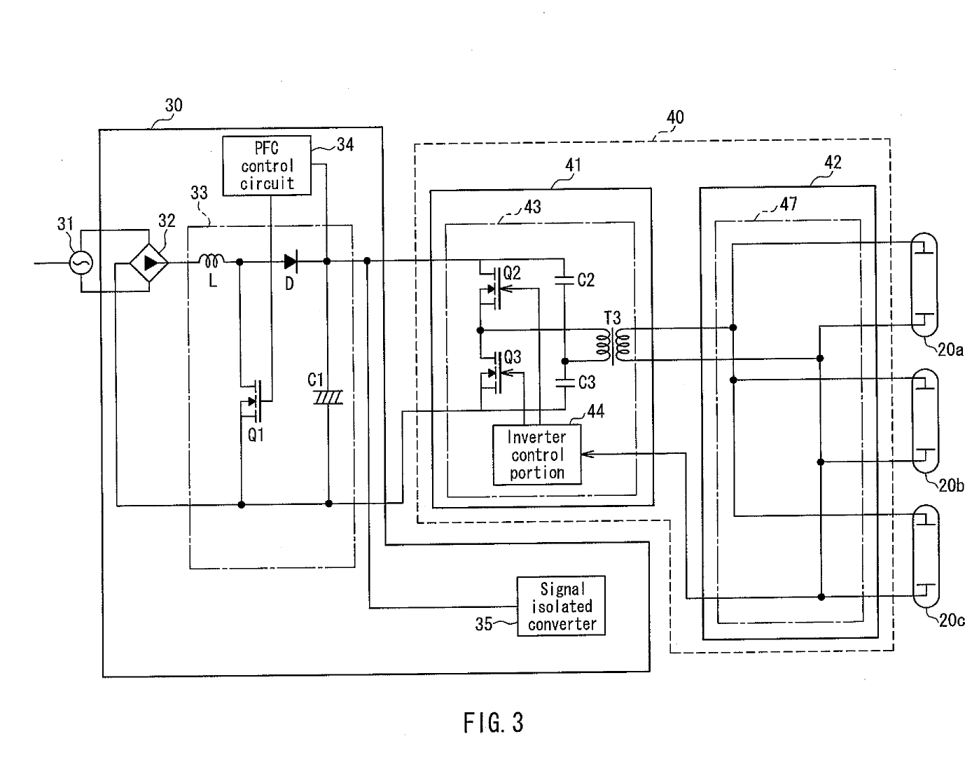

FIG. 3 is a block diagram showing the configuration of the lighting circuit of the backlight device used in the display device according to Embodiment 2 of the present invention. The liquid crystal display device of this embodiment differs from that of Embodiment 1 only in the configuration of the inverter unit of the lighting circuit, and other configurations of the liquid crystal display device and the configuration of the backlight device are the same as those in Embodiment 1. Therefore, the representation and the detailed explanation will not be repeated.

As shown in FIG. 3, the lighting circuit of the backlight device used in the liquid crystal display device of Embodiment 2 includes a power supply unit disposed on a power supply circuit board 30 and an inverter unit 40.

The power supply unit is the same as that of Embodiment 1 shown in FIG. 2, and includes a rectifier 32, a direct-current power supply circuit 33, a PFC control circuit 34, and a signal isolated converter 35. The rectifier 32 is connected to the commercial alternating-current power supply 31 that is input externally via a power code of the liquid crystal display device. The direct-current power supply circuit 33 converts the output of the rectifier 32 into, e.g., a direct-current voltage of 370 V. The PFC control circuit 34 improves the power factor of the direct-current power supply circuit 33 by suppressing harmonics. The signal isolated converter 35 receives the direct-current voltage from the direct-current power supply circuit 33. Also, the configuration and function of each of the rectifier 32, the direct-current power supply circuit 33, the PFC control circuit 34, and the signal isolated converter 35 are the same as those of the lighting circuit of Embodiment 1 shown in FIG. 2.

In the lighting circuit of this embodiment, the inverter unit 40 includes an inverter circuit board 41 and a lighting voltage supply board 42. The lighting circuit of this embodiment differs from that of Embodiment 1 in that the booster portion is an isolation booster transformer T3 provided on the inverter circuit board 41, and an electrode connection circuit 47 is formed on the lighting voltage supply circuit 42.

In this embodiment, the inverter circuit board 41 includes an inverter drive circuit 43. The inverter drive circuit 43 receives the direct-current voltage from the direct-current power supply circuit 33 and generates a high frequency voltage by inverter control. The specific configuration of the inverter drive circuit 43 is the same as that shown in FIG. 2.

A primary coil of the isolation booster transformer T3 (booster portion) is connected between the midpoint between switching elements Q2, Q3 and the midpoint between capacitors C2, C3. A secondary coil of the isolation booster transformer T3 is connected to the electrode connection circuit 47 of the lighting voltage supply board 42. In view of the safety, the isolation booster transformer T3 prevents a direct connection between the power supply unit and the cold-cathode fluorescent tubes.

The electrode connection circuit 47 formed on the lighting voltage supply circuit 42 applies the high frequency alternating-current voltage that has been boosted to the lighting drive voltage by the isolation booster transformer T3 of the inverter drive circuit 43 to the electrodes at both ends of each of the cold-cathode fluorescent tubes 20a to 20c. Specifically, connection terminals (not shown) connected to both electrodes of each of the cold-cathode fluorescent tubes 20a to 20c are connected in parallel to the secondary coil of the isolation booster transformer T3.

To keep track of the lighting states of the cold-cathode fluorescent tubes (lamps) 20a to 20c, one of the connection terminals that are connected to both electrodes of each of the cold-cathode fluorescent tubes 20a to 20c is connected to an inverter control portion 44 of the inverter drive circuit 43. Thus, the inverter circuit stabilizes the supply of the lighting drive voltage and controls the lamp currents of the cold-cathode fluorescent tubes 20a to 20c collectively.

In the lighting circuit of this embodiment, the direct-current power supply circuit 33 and the inverter drive circuit 43, which is a part of the inverter unit 40, are disposed on different circuit boards. By dividing the circuit boards of the lighting circuit for the cold-cathode fluorescent tubes (lamps) serving as light sources, it is possible to increase the margin for design of the placement of the circuit boards on the back of the backlight device. Like the lighting circuit of Embodiment 1, the degree of freedom in the placement of the circuit boards is increased, and although various specifications may be applied to the power supply circuit board depending on the destination and intended use of the liquid crystal display device, the power supply circuit board can be designed and employed independently of the inverter unit. Thus, the manufacturing cost can be reduced.

In the lighting circuit of this embodiment, since the booster portion is the isolation booster transformer T3 in the inverter drive circuit 43, the inverter transformer is not necessary. Therefore, the inverter transformer, which is inevitably large in size as a circuit component, does not have to be formed on the lighting voltage supply board that is located near the electrode portions of the cold-cathode fluorescent tubes in order to make the length of high-voltage wiring installed as short as possible. Accordingly, e.g., when the peripheral portions of the back cover are curved in view of the appearance of the liquid crystal display device, even if the space on the back of the backlight device is reduced due to the curved portions of the back cover, the circuit boards constituting the lighting circuit can be placed. Moreover, the circuit boards to be located near the periphery of the backlight device can have a small area, thus allowing components other than the circuit boards to be located near the periphery of the liquid crystal display device. Consequently, the size and thickness of the liquid crystal display device can be reduced.

In the above description of each of the embodiments of the present invention, the number of the inverter transformers is the same as that of the cold-cathode fluorescent tubes in Embodiment 1. However, the present invention is not limited thereto. For example, a so-called artificial U-shaped tube connection may be employed, in which one of the electrodes of a cold-cathode fluorescent tube is connected to one of the electrodes of another cold-cathode fluorescent tube, and the other electrodes of these cold-cathode fluorescent tubes are connected to both ends of the secondary coil of an inverter transformer, so that the two cold-cathode fluorescent tubes are used just like a single U-shaped fluorescent tube. In such a case, the number of the inverter transformers is reduced to one-half the number of the cold-cathode fluorescent tubes.

In each of the embodiments of the present invention, the cold-cathode fluorescent tube is used as a lamp that is a light source of the backlight device. However, the present invention is not limited thereto, and a hot-cathode fluorescent tube or other lamps also can be used.

Moreover, the lamp is not limited to a straight tube having a circular cross section. For example, an oblate lamp having an elliptical or racetrack-shaped cross section to achieve a large light emission surface and improve the light emission efficiency, a U-shaped tube, or the like can be used.

### INDUSTRIAL APPLICABILITY

The present invention is industrially applicable as a backlight device that improves the margin for design of the placement of the circuit boards constituting the lighting circuit of a lamp, and as a display device including the backlight device as a light source.

1. A backlight device comprising:
a lamp; and
a lighting circuit that generates a lighting drive voltage to light the lamp,
wherein the lighting circuit comprises:
a direct-current power supply circuit that generates a direct-current voltage from an input voltage;
an inverter drive circuit that converts the direct-current voltage output from the direct-current power supply circuit into a high frequency voltage; and
a booster portion that boosts the high frequency voltage output from the inverter drive circuit to a lightning drive voltage of the lamp, and
wherein the direct-current power supply circuit and the inverter drive circuit are disposed on different circuit boards.

2. The backlight device according to claim 1, wherein the booster portion is an inverter transformer in a booster circuit that is disposed on a different circuit board from the inverter drive circuit.

3. The backlight device according to claim 1, wherein the booster portion is an isolation booster transformer that is disposed on the same circuit board as the inverter drive circuit.

4. The backlight device according to any one of claim 1, wherein the lamp is a cold-cathode fluorescent tube.

5. A display device comprising:
a display portion; and
the backlight device according to any one of claim 1,
wherein the display portion is irradiated with light from the backlight device.
